(19) United States
(12) Patent Application Publication
(10) Pub. No.: US 2026/0236715 A1
(43) Pub. Date: Aug. 13, 2026

(54) INFORMATION PROCESSING DEVICE, INFORMATION PROCESSING METHOD, AND INFORMATION PROCESSING PROGRAM

(71) Applicant: NTT, INC., Tokyo (JP)

(72) Inventors: Atsushi OTSUKA, Tokyo (JP); Yukinori HOMMA, Tokyo (JP); Narichika NOMOTO, Tokyo (JP); Ryo ISHII, Tokyo (JP)

(73) Assignee: NTT, INC., Tokyo (JP)

(21) Appl. No.: 19/154,710

(22) PCT Filed: Feb. 8, 2023
(86) PCT No.: PCT/JP2023/004247

§ 371 Date: Aug. 7, 2025

(51) Int. Cl. G06F 40/40

(52) U.S. Cl. CPC G06F 40/40

(57) ABSTRACT

An information processing device includes a memory and processing circuitry configured to extract, from an answer text to a question, a partial text related to a predetermined viewpoint which is prepared in advance, generate a question for which the partial text is an answer based on the extracted partial text and the viewpoint, and output the generated question and the partial text in association with each other.

### TECHNICAL FIELD

The present invention relates to an information processing device, an information processing method, and an information processing program for creating a Q&A suitable for use by a chatbot.

### BACKGROUND ART

A chatbot is a system that allow users to access desired information in a form of interactive questions and answers for text-based articles. Several methods have been proposed for implementing chatbots, and a chatbot in a frequently asked questions (FAQ) format is particularly mainstream.

The FAQ is data including a pair of a question (Q) and an answer (A), and is posted as “frequently asked questions” on a website. The chatbot in the FAQ format uses the FAQ as a knowledge source, matches a question sentence (a query) which is input by a user with a Q in the FAQ, and outputs A corresponding to the Q closest to the query. Various techniques have been proposed for matching the query with a portion of the Q (refer to Patent Literature 1).

### CITATION LIST

### Patent Literature

Patent Literature 1: Japanese Laid-open Patent Publication No. 2017-201478 A

### SUMMARY OF INVENTION

### Technical Problem

However, a problem of the chatbot using the FAQ also exists in a part of the answer (A). The answer (A) in the FAQ is not necessarily information with good readability as an interactive answer.

For example, in a case where, for a Q such as “About the contract method for ∘∘”, there is an A such as “The contract method for ∘∘ is ××, the reception hours is up to ΔΔ, and the response department is located at □□.”, there is a problem that convenience for a user is reduced since A having a long sentence as described above is output to a user who wants to know only the reception hours or a user who wants to know only the response department.

Further, in the above case, since Q such as “About the contract method for ∘∘” is matched with a user's query such as “I want to know the reception hours for ∘∘”, a degree of matching between Q and the query is lowered, and as a result, A may not be output to the user.

Therefore, the present invention has been made to solve the above-described problems, and an object of the present invention is to create a Q&A suitable for use by a chatbot from FAQs or the like.

### Solution to Problem

In order to solve the above-mentioned problems, the present invention includes: a text extraction unit that extracts, from an answer text to a question, a partial text related to a predetermined viewpoint which is prepared in advance; a question generation unit that generates a question for which the partial text is an answer based on the extracted partial text and the viewpoint; and an information output unit that outputs the generated question and the partial text in association with each other.

### Advantageous Effects of Invention

According to the present invention, it is possible to create a Q&A suitable for use by a chatbot from FAQs or the like.

### BRIEF DESCRIPTION OF DRAWINGS

FIG. 1 is a diagram for explaining an example of processing executed by an information processing device.

FIG. 2 is a diagram for explaining an outline of the information processing device.

FIG. 3 is a diagram illustrating a configuration example of the information processing device.

FIG. 4 is a flowchart illustrating an example of a processing procedure executed by the information processing device.

FIG. 5 is a diagram illustrating a computer that executes an information processing program.

### DESCRIPTION OF EMBODIMENTS

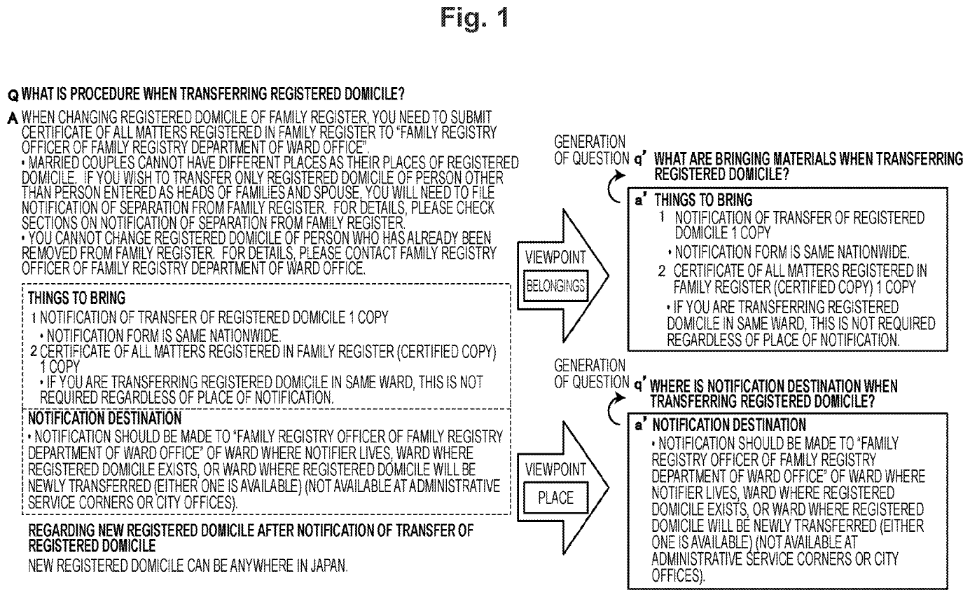

Hereinafter, modes (embodiments) for carrying out the present invention will be described with reference to the drawings. The present invention is not limited to the present embodiment.

[Outline] First, an outline of an information processing device according to the present embodiment will be described with reference to FIG. 1. The information processing device acquires, for example, an answer text (A) of an FAQ from a web page disclosing FAQS. In addition, the information processing device extracts an answer portion related to an input viewpoint (for example, “belongings”, “place”, or the like) from the acquired answer text (A).

For example, as illustrated in FIG. 1, it is considered a case where, for a question Q “What is the procedure when transferring the registered domicile?”, an answer text A is a relatively long text such as “When changing the registered domicile of family register, . . . ”. Here, A includes information from a plurality of viewpoints, such as information related to belongings required for the procedure and information related to a notification destination (a place) of the procedure.

In this case, for example, in a case where a viewpoint “belongings” is input to the information processing device, the information processing device extracts a partial answer text (a partial text) a′ “things to bring . . . ” related to “belongings” from A.

In addition, the information processing device generates a question q′ corresponding to the extracted partial answer text a′. For example, the information processing device generates a question q′ such as “What are bringing materials when transferring the registered domicile?” as a question for the partial answer text a′ “things to bring . . . ”.

Thereafter, the information processing device outputs the question q′ “What are bringing materials when transferring the registered domicile?” and the partial answer text a′ “things to bring . . . ” as a new Q&A set.

Further, for example, in a case where a viewpoint “place” is input to the information processing device, the information processing device extracts a partial answer text a′ “notification destination . . . ” related to “place” from A.

In addition, the information processing device generates a question q′ corresponding to the extracted partial answer text a′. For example, the information processing device generates a question q′ such as “Where is the notification destination when transferring the registered domicile?” as a question for the partial answer text a′ “notification destination . . . ”.

Thereafter, the information processing device outputs the question q′ “Where is the notification destination when transferring the registered domicile?” and the partial answer text a′ “notification destination . . . ” as a new Q&A set.

Thereby, even in a case where A for one Q in the FAQ is a long sentence, the information processing device can divide the Q&A, and output the reconfigured information (the new Q&A set). Therefore, the information processing device can create a Q&A suitable for use by a chatbot.

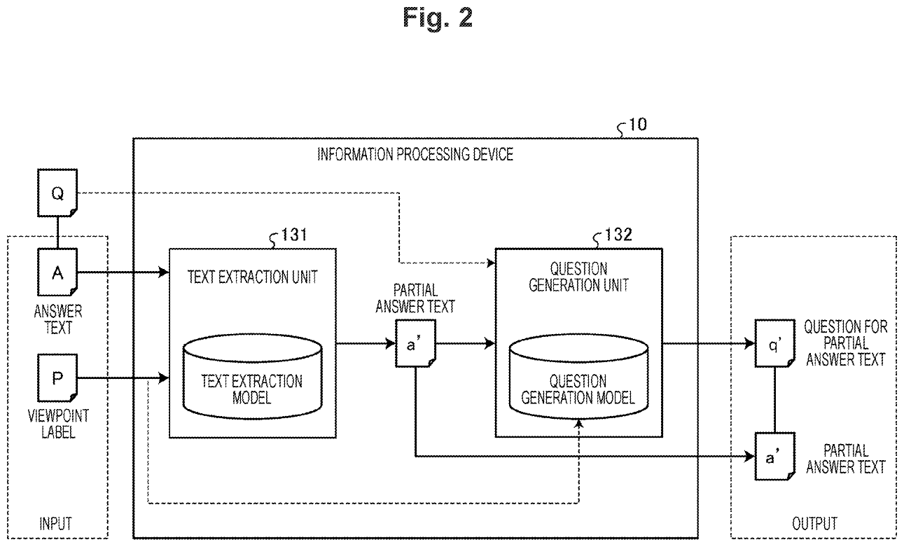

Next, an outline of the information processing device will be described in more detail with reference to FIG. 2. The information processing device 10 includes, for example, a text extraction unit 131 that extracts a partial answer text (a′) of an input viewpoint (P) from an answer text (A) in the FAQ, and a question generation unit 132 that generates a question (q′) for which the partial answer text (a′) is an answer.

In a case where an input of the answer text (A) and the viewpoint label (P) is received, the text extraction unit 131 extracts a partial answer text (a′) of the viewpoint (P) from the answer text (A) by using a machine learning model (for example, a text extraction model, details will be described later).

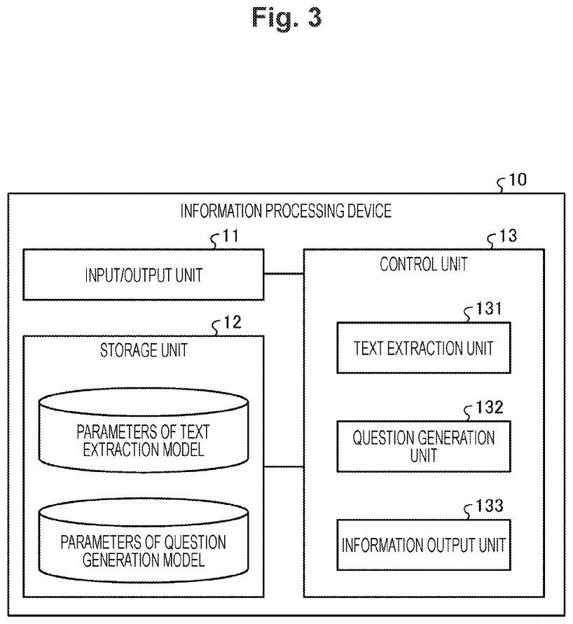

Next, the question generation unit 132 generates a question (q′) for which the partial answer text (a′) extracted by the text extraction unit 131 is an answer by using a machine learning model (for example, a question generation model, details will be described later). In addition, the information processing device 10 outputs the generated question (q′) and the partial answer text (a′) in association with each other.

[Configuration Example] Next, a configuration example of the information processing device 10 will be described with reference to FIG. 3. The information processing device 10 includes, for example, an input/output unit 11, a storage unit 12, and a control unit 13.

The input/output unit 11 is an interface that controls input and output of various types of data. The input/output unit 11 receives an input of a question (Q) and an answer text (A) for the question from, for example, a web page including FAQs.

The storage unit 12 stores data, programs, and the like that are referred to in a case where the control unit 13 executes various types of processing. The storage unit 12 is implemented by a semiconductor memory element such as a random access memory (RAM) or a flash memory, or a storage device such as a hard disk or an optical disk. For example, the storage unit 12 stores parameters of the text extraction model, parameters of the question generation model, and the like that are to be used by the control unit 13.

The control unit 13 controls the entire information processing device 10. The function of the control unit 13 is implemented, for example, in a case where a central processing unit (CPU) executes a program stored in the storage unit 12.

The control unit 13 includes, for example, a text extraction unit 131, a question generation unit 132, and an information output unit 133.

[Text Extraction Unit] The text extraction unit 131 extracts a partial answer text related to the input viewpoint from the answer text to the question.

For example, the information processing device 10 acquires a question (Q) and an answer text (A) that are disclosed on a web page including FAQS. In addition, the information processing device 10 receives an input of information (a viewpoint label) indicating which viewpoint of the partial answer text of the answer text (A) is to be extracted. Thereafter, the text extraction unit 131 extracts a partial answer text (a′ (a′∈A) ) of the input viewpoint from the answer text (A) in the FAQ.

A machine learning model (a text extraction model) is used to extract the partial answer text. As the text extraction model, for example, a machine reading model described in Literature 1 (WO2019/106965) is used. In a case where a question and an answer target text (a text including an answer portion to the question) are input, the machine reading model extracts an answer portion to the question from the answer target text, and outputs the answer portion.

Here, by setting a question sentence that is input to the machine reading model as a “viewpoint” and an answer target text that is input to the machine reading model as an “answer text (A)”, the text extraction unit 131 can extract a partial answer text related to the input viewpoint from the answer text (A).

Further, as the above text extraction model, for example, a text generation model described in Literature 2 may be used. Here, in a case where a text obtained by connecting the “viewpoint” and the “answer text (A)” is input to the generation model, learning of the above generation model is performed to generate a partial answer text related to the “viewpoint”. In addition, the text extraction unit 131 can extract a partial answer text related to the input viewpoint from the answer text (A) by using the learned generation model as the text extraction model.
Literature 2: Hiroaki Sugiyama, et. al, Empirical Analysis of Training Strategies of Transformer-based Japanese Chit-chat Systems. 2021.https://arxiv.org/abs/2109.05217

Further, as the viewpoint label, a text string of an arbitrary natural sentence may be used. The viewpoint label may represent an attribute (for example, “time”, “place”, or the like) of the partial answer text as an extraction target, or may represent a topic name (for example, “sports”, “technology”, or the like) of the partial answer text as an extraction target. In addition, the viewpoint label may be a combination of a plurality of words, or may be expressed as a sentence.

A format of the partial answer text that is output by the text extraction unit 131 is a natural sentence. Here, in a case where the answer text includes a plurality of partial answer texts corresponding to the viewpoint label, the text extraction unit 131 outputs each of the plurality of partial answer texts corresponding to the viewpoint label.

Further, in a case where the text extraction unit 131 cannot extract the partial answer text corresponding to the viewpoint label from the answer text, the text extraction unit 131 may not output anything or may output a signal including a flag (for example, 0) indicating that the partial answer text cannot be extracted.

[Question Generation Unit] The question generation unit 132 generates a question for which the partial answer text extracted by the text extraction unit 131 is an answer. For example, the question generation unit 132 generates a question for which the partial answer text is an answer based on the partial answer text, the viewpoint used for extracting the partial answer text, and the answer text.

In order to generate the question, for example, a machine learning model (a question generation model) is used. The question generation model is, for example, a machine learning model that receives, as an input, the partial answer text (a′) , the viewpoint label (P), and the answer text (A), generates a question (q′) for which the partial answer text (a′) is an answer, and outputs the question (q′) .

As the question generation model, for example, it is possible to use a machine learning model obtained by performing learning in advance to receive, as an input, an answer and a viewpoint label and output a question for the answer, by using a data set including the answer of the question, the viewpoint label of the answer, and the question for the answer.

Here, the answer text (A) is used, for example, to reinforce information of the partial answer text (a′) .

For example, in a case where an input of a partial answer text (a′) such as “The response department is located at □□” and a viewpoint “place” is received, the question generation model may generate a simple question such as “Where is the response department?”.

Therefore, by further inputting, for example, the entire answer text such as “The contract method for ∘∘ is ××, the reception hours is up to ΔΔ, and the response department is located at □□.” to the question generation model, for example, a question with specific contents such as “Where is the response department for making a contract for ∘∘?” can be generated.

In addition, a question (Q) may be further input to the question generation model. The question (Q) is used to unify expressions such as wording when generating a question (q′) for the partial answer text (a′) .

For example, in a case where the question generation model generates a question sentence (q′) such as “Where is the response department for ∘∘?” for a question sentence (Q) such as “Please tell me the contract method for ∘∘”, style of the question sentence (q′) is not unified with a style of the question sentence (Q). Therefore, by inputting the question sentence (Q) to the question generation model, the question sentence (q′) having the same style as the input question sentence (Q) can be generated.

Note that, in a case where the chatbot performs processing of normalizing expressions of styles or the like when matching a query from a user with the question (q′) , it is not necessary to unify the style of the question sentence (q′) as described above. Therefore, in the above case, it is not necessary to input the question (Q) to the question generation model.

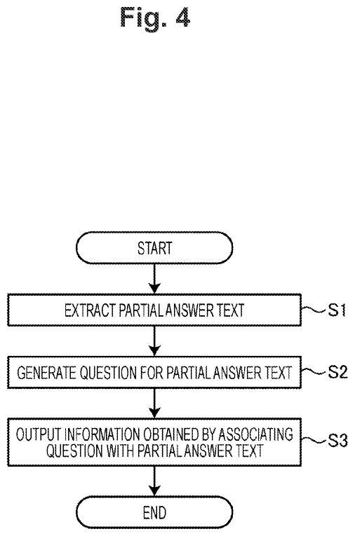

Note that, in a case where the text extraction unit 131 extracts a plurality of partial answer texts (a′) for one viewpoint from the answer text (A), the question generation unit 132 generates a question (q′) for each of the plurality of partial answer texts (a′) .

[Information Output Unit] The information output unit 133 outputs the question (q′) generated by the question generation unit 132 and the partial answer text (a′) in association with each other. For example, the information output unit 133 outputs information obtained by associating the question (q′) with the partial answer text (a′) in a Q&A database used by the chatbot.

[Example of Processing Procedure] Next, an example of a processing procedure executed by the information processing device 10 will be described with reference to FIG. 4. For example, the text extraction unit 131 extracts a partial answer text related to the input viewpoint (P) from the answer text (A) in the FAQ (S1). Next, the question generation unit 132 generates a question for which the partial answer text extracted in S1 is an answer (S2: generation of a question for the partial answer text). Thereafter, the information output unit 133 outputs information obtained by associating the question that is generated in S2 with the partial answer text that is extracted in S1 (S3).

[Other Embodiments] Note that, in a case where the text extraction unit 131 cannot extract a partial answer text (a′) corresponding to the viewpoint label (P) from the answer text (A), the question generation unit 132 may generate a question (q′) for the answer text (A),

For example, the information processing device 10 further includes a determination unit that determines whether or not the text extraction unit 131 can extract a partial answer text (a′) . In addition, in a case where the determination unit determines that the text extraction unit 131 cannot extract a partial answer text (a′) , the question generation unit 132 generates a question (q′) by inputting the viewpoint label (P) and the answer text (A) to the question generation model.

Thereafter, a user of the information processing device 10 creates an answer to the generated question (q′) , and inputs the answer to the information processing device 10. In addition, the information output unit 133 outputs the generated question (q′) and the answer created by the user in association with each other. Thereby, a Q&A that does not exist in the FAQ so far can be added to a Q&A database used by the chatbot.

Note that the description has been given assuming that the text extraction model outputs the partial answer text (a′) in a form of a natural sentence from the answer text (A) and the question generation model generates, for the partial answer text (a′) , the question (q′) for which the partial answer text (a′) is an answer in the form of a natural sentence. On the other hand, the present invention is not limited thereto.

For example, instead of the partial answer text (a′) in the form of a natural sentence, the question generation model may generate a question (q′) using a vector (a vector indicating the partial answer text (a′) ) that is output when the text extraction model extracts the partial answer text (a′) .

In addition, the description has been given assuming that information processing device 10 executes the above processing using two machine learning models such as the text extraction model and the question generation model.

On the other hand, the above processing may be executed by one machine learning model having the functions of the text extraction model and the question generation model.

Further, the text extraction unit 131 extracts the partial answer text (a′) based on the viewpoint that is input from the user. On the other hand, the present invention is not limited thereto. For example, the text extraction unit 131 may extract the partial answer text (a′) based on a predetermined viewpoint that is prepared in advance. The viewpoint is, for example, a viewpoint that is used with a relatively high frequency, and is stored in the storage unit 12. For example, the viewpoint may be set by the user, or may be a viewpoint that has been frequently used in the information processing device 10 so far.

[System Configuration and the like] In addition, each component of each illustrated unit is functionally conceptual, and does not necessarily have to be physically configured as illustrated. That is, a specific form of distribution and integration of each device is not limited to the illustrated form, and all or a part of the devices can be functionally or physically distributed and integrated in an arbitrary unit according to various loads, usage conditions, and the like. Further, all or some of the processing functions performed by the devices can be implemented by a CPU and a program executed by the CPU, or can be implemented as hardware by wired logic.

Further, in pieces of the processing described in the above embodiment, all or some of the pieces of the processing described as being automatically performed may be manually performed, or all or some of the pieces of the processing described as being manually performed may be automatically performed by a known method. In addition, the processing procedure, the control procedure, the specific name, and information including various types of data and parameters described in the above literature and drawings can be optionally changed unless otherwise mentioned.

[Program] The information processing device 10 can be implemented by installing a program (an information processing program) as package software or online software in a desired computer. For example, by causing an information processing device to execute the above program, the information processing device can be caused to function as the information processing device 10. Here, the information processing device includes a mobile communication terminal such as a smartphone, a mobile phone, and a personal handyphone system (PHS) and a terminal such as a personal digital assistant (PDA).

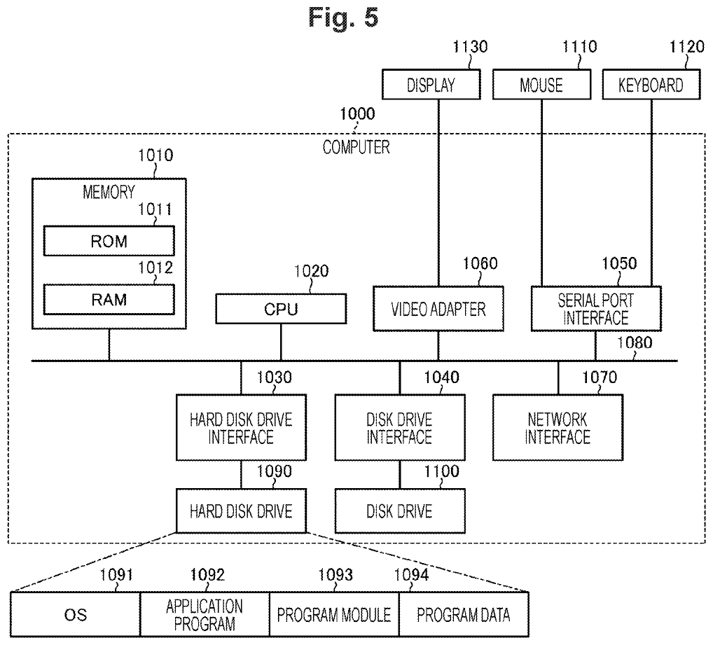

FIG. 5 is a diagram illustrating an example of a computer that executes an information processing program. A computer 1000 includes, for example, a memory 1010 and a CPU 1020. In addition, the computer 1000 includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100.

The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each piece of processing executed by the above information processing device 10 is implemented as a program module 1093 in which a code executable by a computer is described. The program module 1093 is stored in, for example, the hard disk drive 1090. For example, the program module 1093 for executing processing similar to the functional configuration in the information processing device 10 is stored in the hard disk drive 1090. Note that the hard disk drive 1090 may be replaced with a solid state drive (SSD).

Further, data used in the processing of the above embodiment is stored in, for example, the memory 1010 or the hard disk drive 1090 as the program data 1094. In addition, the CPU 1020 reads the program module n 1093 and the program data 1094 stored in the memory 1010 and the hard disk drive 1090 into the RAM 1012 as necessary, and executes the program module 1093 and the program data 1094.

Note that the program module 1093 and the program data 1094 are not limited to being stored in the hard disk drive 1090. For example, the program module 1093 and the program data 1094 may be stored in a detachable storage medium, and may be read by the CPU 1020 via the disk drive 1100 or the like. Alternatively, the program module 1093 and the program data 1094 may be stored in another computer connected via a network (a local area network (LAN), a wide area network (WAN), or the like). In addition, the program module 1093 and the program data 1094 may be read by the CPU 1020 from another computer via the network interface 1070.

### REFERENCE SIGNS LIST

10 Information processing device
11 Input/output unit
12 Storage unit
13 Control unit
131 Text extraction unit
132 Question generation unit
133 Information output unit

1. An information processing device comprising:
a memory; and
processing circuitry configured to:
extract, from an answer text to a question, a partial text related to a predetermined viewpoint which is prepared in advance;
generate a question for which the partial text is an answer based on the extracted partial text and the viewpoint; and
output the generated question and the partial text in association with each other.

2. The information processing device according to claim 1, wherein the predetermined viewpoint is a viewpoint that is input by a user.

3. The information processing device according to claim 1, wherein the processing circuitry is further configured to generate the question by a machine learning model obtained by performing learning using, as a data set, a question, an answer to the question, and a viewpoint of the answer.

4. The information processing device according to claim 1, wherein, in a case where a plurality of partial texts related to the viewpoint is extracted from the answer text to the question, the processing circuitry is further configured to generate a question for which the partial text is an answer for each of the plurality of partial texts.

5. The information processing device according to claim 1, wherein, in a case where a machine learning model that receives an input of a question and an answer text to the question and extracts an answer portion to the question from the answer text is provided, the processing circuitry is further configured to extract a partial text related to the viewpoint from the answer text by inputting the viewpoint as the question to the machine learning model.

6. The information processing device according to claim 1, wherein the processing circuitry is further configured to:
determine whether or not the partial text can be extracted,
in a case where the processing circuitry determines that the partial text cannot be extracted, generate a question for which the answer text is an answer based on the answer text and the viewpoint, and
output the generated question and an answer to the question that is input from a user in association with each other.

7. An information processing method executed by an information processing device, the information processing method comprising:
extracting, from an answer text to a question, a partial text related to a predetermined viewpoint which is prepared in advance;
generating a question for which the partial text is an answer based on the extracted partial text and the viewpoint; and
outputting the generated question and the partial text in association with each other.

8. A non-transitory computer-readable recording medium storing therein an information processing program that causes a computer to execute a process comprising:
extracting, from an answer text to a question, a partial text related to a predetermined viewpoint which is prepared in advance;
generating a question for which the partial text is an answer based on the extracted partial text and the viewpoint; and
of outputting the generated question and the partial text in association with each other.
